(19) United States
(12) Patent Application Publication
(10) Pub. No.: US 2017/0074248 A1
(43) Pub. Date: Mar. 16, 2017

(54) WIND TURBINE STATION AND TOWER WITH VERTICAL STORAGE TANKS

(71) Applicants: Ben M. Enis, Henderson, NV (US); Paul Lieberman, Torrance, CA (US)

(72) Inventors: Ben M. Enis, Henderson, NV (US); Paul Lieberman, Torrance, CA (US)

(21) Appl. No.: 14/849,685

(22) Filed: Sep. 10, 2015

(51) Int. Cl. F03D 9/00; F03D 80/80; F03D 80/60; F03D 1/06; F03D 9/17

(52) U.S. Cl. CPC F03D 9/001; F03D 1/06; F03D 9/005; F03D 9/17; F03D 80/60; F03D 80/82; F03D 80/88

(57) ABSTRACT

The invention relates to a wind turbine station and tower as well as wind farms using them, wherein each wind turbine station comprises a tower consisting of preferably two or more vertically oriented compressed air pressure storage tanks or vessels. The tanks or vessels are preferably comprised of vertically oriented elongated steel pipes that are extended parallel to each other and spaced apart with a steel web between them for reinforcing the strength and rigidity and moment resistance of the tower to resist lateral wind forces that may be applied to the top of the tower. Various numbers and confirmations of pipes are contemplated to provide the advantages described herein.

### FIELD OF THE INVENTION

The present invention relates to wind turbines for the generation of electricity and other forms of energy and in particular to a wind turbine station and tower with vertically oriented storage tanks or vessels for storing compressed air energy.

### BACKGROUND OF THE INVENTION

While attempts have been made to reduce reliance on foreign oil, many energy experts fear that some of these resources, including oil, gas and coal, may someday run out. Because of these concerns, projects have been initiated in an attempt to harness energy from what are often referred to as natural “alternative” sources—sources that will never become depleted. And due to increased energy demands, and energy costs, energy providers have begun to seriously consider the feasibility and use of energy derived from those sources including the sun and wind.

Most populated areas of the country have adequate availability of electricity, such as those provided by local utility companies and distributed through large power grids. In some remote areas, however, the cost of running overhead or underground cables from the nearest grid to the end user can be prohibitively high, and therefore, electrical power is not always readily available. And to make matters worse, the cost of installing an energy generating facility in such locations is normally incurred by the end user, such as where land is privately owned and public utility companies have no obligation to service those areas. Moreover, even if power lines are provided to these locations, significant power losses can occur due to great distances, wherein the energy that travels through the lines can be significantly diminished by the time it reaches its destination. Thus, people who live high in the mountains or in other remote areas often need to develop and provide their own energy systems, etc.

While solar power is one of the most widely known sources of naturally occurring energy, there is also the potential for harnessing tremendous energy from the wind. Wind farms, for example, have been built in many areas of the world, i.e., windmills are typically built and “aimed” toward the wind, so that when the wind blows, rotational power is created and used to drive generators, which in turn, can generate electricity. This energy is often used to supplement energy produced by utility plants and distributed through grids.

One drawback to using wind as an energy source, however, is that the wind does not always blow, and even if it does, it does not always blow consistently at the same speed, i.e., it is often unpredictable, and therefore, it is not always a reliable form of energy, and the amount of wind derived energy will differ significantly from time to time and from location to location. While some attempts have been made to store energy produced by the wind so it can be used later during peak demand periods, or when the wind is not blowing hard enough, these attempts have not yet produced systems that are sufficiently efficient, nor have they been able to reduce the costs and difficulties associated with using wind as an energy source.

For example, past attempts include using batteries to store electricity as well as large steel tanks or underground caverns to store compressed air energy, but these attempts have not been successful mainly due to their excessive costs. Indeed, when taking into account the cost of constructing wind turbines, etc., and the cost of constructing the storage tanks and other related equipment, including the towers, as well as the potential energy losses attributable to converting energy from one form to another, it has not always been cost effective to develop these types of systems.

Past attempts to store energy in the form of compressed air energy include using large costly steel tanks and underground caverns. And, when taking into account the amount of storage space normally required for a facility like this to store energy, it is often cost prohibitive to build large steel tanks and vessels to hold the compressed air needed to supply the necessary power. And, while the cost of using an existing underground cavern for storing compressed air is relatively low compared to using steel tanks, the downside is that there are only a few areas in existence that have caverns large enough and airtight enough for storing compressed air energy, and even when there is such a site, the facility that uses the cavern will have to be built directly above the cavern, which may or may not be feasible or even possible.

Notwithstanding these problems, because wind is a significant natural resource that will never run out, and is often in abundance in many areas of the world, there is a desire to develop a system that can harness wind energy and produce electrical power, but to do so in a predictable, reliable, consistent and cost-effective manner.

### SUMMARY OF THE INVENTION

The present invention relates to wind turbine stations and towers and wind farms that use them for generating energy from the wind, wherein each wind turbine station preferably comprises a tower with a substantially vertically oriented high pressure storage vessel or tank for storing compressed air energy generated by a compressor associated therewith. The tower is preferably extended substantially vertically and comprises multiple storage pipes that are positioned side by side on which the wind turbine blades and nacelle are mounted. The tower is preferably high enough to enable the wind turbine blades to access the greater wind speeds that exist at higher elevations, and is preferably high enough to provide a sufficient amount of storage volume inside the storage vessel or tank for storing the compressed air energy generated by the compressor.

The wind turbine preferably comprises blades that are extended from a nacelle and adapted to rotate as the wind blows against the blades. The blades are preferably extended about an axis that is substantially horizontally oriented and connected to an energy converting device which converts the rotational energy of the blades into a usable form, such as electricity, or storable form, such as compressed air, or both.

In one embodiment, each nacelle preferably consists of a compressor for generating compressed air energy, wherein the mechanical energy produced by the wind as the blades rotate can be used to produce compressed air energy which can be stored directly into the pressure vessel or tank. This is advantageous because the energy does not have to be converted into electricity before it is used to drive the compressor.

In another embodiment, a generator for generating electricity can be provided within the nacelle, wherein the rotational movement of the blades can be used to drive an electrical generator, which in turn, produces electricity that can either be transmitted down the tower to drive a compressor located on the ground or drive a compressor located within the nacelle.

In either case, the compressed air energy produced by the compressor is preferably stored in the vessel or tank, such that it can be used later, and/or used to supply electricity directly to the end user or grid without storing it first. In such case, a switch is preferably provided that enables the system to be switched between supplying electricity for immediate use and producing compressed air energy for storage. This last situation can occur when the wind is blowing relatively hard, and there is more energy being produced than there is demand for that energy, or, even when the wind is not blowing very hard, when the demand is sufficiently low enough that extra wind energy is available for putting into storage.

In another embodiment, both the compressor and generator can be located in the nacelle, wherein a switch can be provided that enables the station to be switched between generating electricity for immediate use, on one hand, and compressing air into storage, on the other hand, i.e., similar to a hybrid station. A drive gear system, for example, can be provided that allows the rotational energy from the wind to be spit between the compressor on one hand and the generator on the other hand, wherein the distribution of energy is based on the gear ratios that are provided in connection with the drives. When there is excess energy available beyond that needed for immediate use, the compressor can be turned on and used to produce compressed air energy, which can then be stored in the vessel or tank and made available for later use. On the other hand, when there is a sufficient amount of compressed air energy available in storage, or whenever it is desirable to provide electricity directly, the system can be switched to allow the generator to produce electrical power that can be used immediately by the end user or grid.

In a variation of that embodiment, the energy producing system can be adapted such that it can always be set to generate electricity for immediate use, without regard to how much energy is provided in storage. In such case, a logic circuit or control system is preferably provided that allows the rotational energy from the wind to be converted into electricity to the extent it is needed, and the leftover or surplus energy is converted into compressed air energy and stored in the vessel or tank. In such case, a drive gear system can be provided that allows the rotational energy from the wind to be spit between the compressor on one hand and the generator on the other hand, wherein the amount of distribution of energy to either is based on the gear ratios that are engaged in the drive gears relative to either destination.

Regardless of the embodiment, the compressed air in storage is preferably converted into a usable form such as electricity at the appropriate time so that it can be made available to supplement the energy provided by the grid or other source. This is preferably done by releasing the compressed air in the vessel or tank using a turbo expander and generator set located on the ground that can produce not only electricity as the air is expanded, but also chilled air usable for ancillary purposes, such as refrigeration, air conditioning, desalination and the like.

In whatever situation applies, the compressor preferably helps to remove the moisture from the input air before it is introduced into the vessel for storage using heat exchangers, etc. This helps to reduce the amount of water that can otherwise collect within the vessel, as well as the moisture that can be introduced into the turbo expander when the compressed air is released.

In one aspect, when large diameter pipes are used that make up the storage tanks or vessels, the pipes are preferably vertically oriented so that they occupy a relatively small footprint on the ground—unlike horizontally oriented storage tanks which are often used in applications such as these. And, by orienting the pipes substantially vertically, they can also double as the supporting tower on which the nacelle and wind turbine blades are mounted, such that they can be extended higher into the air where wind velocities are greater. And by using large pipes to support the wind turbine blades, and simultaneously adapting them to store compressed air energy, the cost of building the wind turbine stations overall, including the cost of the vessels and tower and related components, including but not limited to, the blades, compressors, turbo expanders, generators, heat exchangers, etc., can be significantly reduced. In fact, in conventional wind turbine stations, the cost of building the tower can represent about fifty percent of the total cost of the wind turbine station itself, which is in addition to the cost of building the storage tanks, etc.

While the tower of the present invention can be made using a single large diameter pipe, the preferred design incorporates at least two large diameter pipes extending substantially vertically upward from the ground, wherein each is preferably extended parallel to each other, with a predetermined space in between each one, wherein adjacent pipes can be connected together using a steel vertically oriented plate or web extending between them. By using this configuration, and connecting the web between two vertically oriented pipes, the web can be designed to provide additional rigidity to the tower, which can be helpful in resisting any wind generated moment forces that can be applied to the top of the tower. It is also possible to provide access to the top of the tower by placing a ladder and safety cage or elevator, etc., on the web.

In the preferred embodiment, two vertically oriented pipes are extended parallel to each other, upward from the ground, wherein a steel web is extended between them, wherein the pipes can be anywhere from about two to four or more feet in diameter, and the web can be anywhere from two to five feet or more in width extending in between them. And, preferably, in this embodiment, the two pipes are substantially vertically oriented such that the vertical axis of each pipe is extended perpendicularly through (or substantially near) the horizontal axis of the wind turbine blades, with one pipe in front and one pipe in back, such that the configuration of the tower increases its flexural rigidity and ability to resist wind generated moment forces applied against the top of the tower by the wind. That is, by positioning the two pipes vertically, side by side, with their axis perpendicularly intersecting the horizontal axis of the wind turbine blades, and extending a web section between them, the flexural strength and moment resistance of the tower can be increased in that direction, which in turn, helps resist bending and moment stresses exerted by wind forces blowing in that direction against the top of the tower.

In another aspect, at least a portion of each pipe in the tower is preferably extended into the ground, not only so that the ground can provide support for the tower, but also because of the additional thermal conductivity properties provided by the surrounding ground and supporting material such as concrete that can help to enable the temperature of the air inside the vessel to be better controlled and regulated. This is made necessary or is otherwise beneficial because the temperature of the air can be increased as the air is compressed into the vessel by the compressor, and/or the temperature can be decreased as the air is expanded from the vessel and released by the turbo expander. The thickness and size of the pipes can also help better control the temperature of the air inside.

In the preferred embodiment, the wind turbine station preferably has two large pipes oriented upward with a first pipe having a vertical axis extending through or substantially near the front end of the nacelle, and a second pipe having a vertical axis extending through or substantially near the rear end of the nacelle, with both vertical axis extending through or substantially near the horizontal axis of the wind turbine blades, which helps to ensure that the greatest resistance to bending and moment forces coincides with the wind direction, i.e., the same direction as the horizontal axis of the blades. A thick steel web that helps to increase the moment resistance of the tower is also preferably provided, wherein the web extends between the pipes to form what is substantially similar to an I-beam in cross section extended vertically upward, wherein the pipes act as the flanges, and the web extends between them to resist the shear forces that are exerted thereon.

The number and configuration of tanks or vessels, including how many pipes that are used for each tower and how the pipes are to be oriented, etc., is preferably adaptable to maximize the flexural strength and rigidity and moment resistance of the towers, which in turn, helps to resist the bending forces that can be created as the wind blows against the wind turbine blades. This enables the towers to be built higher, which enables them to access higher speed wind conditions at higher elevations, which can increase the efficiency of the wind turbine station—more power can be generated by the same turbine. This can also make it possible for wind turbine stations to be built with greater storage capacities and avoid upwind obstructions, including adjacent wind towers, or ground conditions, such as hills or mountains, which can interfere with the wind blowing against the blades and therefore the generation of power. Additional embodiments with additional vessels or pipes can be provided to not only increase the storage capacity of the towers, but also increase the flexural strength and rigidity and moment resistance of the towers in different directions other than in the direction of the axis of the blades. In this respect, it can be seen that by providing and orienting other pipes so that their vertical axis do not extend through the same horizontal axis as the blades, the tower can be made to resist additional bending and flexural forces in other directions, i.e., more than just the direction that coincides with the horizontal axis of the blades. Indeed, given that the wind will normally blow in many directions, it can be seen that the tower may be built to resist bending and moment forces in more than just one direction, particularly when the tower is made higher, thereby exposing the blades to greater wind speeds at greater heights. When a tower is built higher, the potential exists for not only greater wind speeds to exist at the top of the tower, but also substantially greater bending and moment forces applied to the tower, which translates into higher compression and tensile forces created along the length of the tower. In such case, it will become more important for towers that are built higher to withstand greater moment forces and more extreme conditions, and thus, being able to use more than two pipes, and orienting them along different axis, can help to expand the potential scope of resistance where these types of wind turbine stations can be used. When three or more pipes are used, for example, they can form a non-linear pattern, wherein the tower can resist greater wind forces in more than one direction, to accommodate the possibility that the wind will blow in various directions at different times. For example, three pipes can be provided to form a triangular configuration, which helps to increase flexural strength and rigidity and moment resistance in at least three directions, and thereby, resist wind forces on the tower in multiple directions. When three vertical pipes are oriented in this manner, a first pipe is preferably extended with its vertical axis extending through or substantially near the front end of the nacelle, as well as perpendicularly through or near the horizontal axis of the blades, and the second and third pipes are preferably extended with their vertical axis substantially equidistant from the first pipe, substantially near or across the rearward part of the nacelle, substantially equidistant from the horizontal axis of the blades. And, preferably extended between the adjacent pipes are webs that connect the pipes together, to form the triangular configuration, and which provide greater strength, rigidity and moment resistance to the tower design by withstanding the shear forces that may be applied between the pipes. Access to the top of the tower can also be provided on one or more webs, such as by building a ladder with a safety cage around it, or an elevator, etc., onto the web between the pipes.

Embodiments with four pipes can also be provided which can be accomplished in a variety of ways. For example, the four vertical pipes can be oriented in a substantial T configuration, with the first pipe having a vertical axis extended through or substantially near the front end of the nacelle (as well as near or through the horizontal axis of the blades), and the other three pipes extended substantially rearward toward the back of the nacelle, such as along a line that is substantially perpendicular to the horizontal axis of the blades. In such case, along the back, the middle pipe preferably has a vertical axis extended through or near the horizontal axis of the blades, while the other two pipes are oriented on either side, such as substantially equidistant from the horizontal axis of the blades. In such case, a web is preferably extended between the front pipe and middle pipe, and then, on either side of the middle pipe, between the middle pipe and two side pipes. This not only increases the strength and rigidity and moment resistance provided by the tower, but also allows for a ladder and safety case or an elevator to be extended to the top of the tower.

Another embodiment using four vertical pipes can comprise a substantially square shape, or rectangular or diamond configuration, wherein the first pipe preferably has a vertical axis extended through or substantially near the front of the nacelle (as well as through or substantially near the horizontal axis of the blades). The second and third pipes can then be oriented such that their vertical axis are extended substantially equidistant from the middle of the nacelle, rearward from the first pipe, on either side of the horizontal axis of the blades. The fourth pipe in such case preferably has a vertical axis extended through or substantially near a rearward part of the nacelle, as well as through or substantially near the horizontal axis of the blades.

In such case, four webs are preferably extended between the four pipes, around the exterior thereof, thereby forming a square, rectangular or diamond shape from above. The webs not only increase the strength and rigidity and moment resistance of the tower, but also allow for a ladder and safety cage or an elevator to be extended to the top of the tower.

While the preferred embodiments have multiple pipes that are substantially parallel to each other with a web connecting them, other configurations, including pipes that are not parallel to each other, that may form a pyramid shape are also contemplated (with or without webs). Generally speaking, a wind farm can be created by using more than one wind turbine station of the type described herein, including any mixture of different types of wind turbine stations. For example, in a small application, three wind turbine stations of the type described above can be provided, wherein each tower can have its own compressor and/or electrical generator, and wherein a separate turbo expander and generator set can be provided for each wind turbine station, or one can be provided in connection with all three stations. In the latter case, to enable compressed air to travel from one station to another, or one tower to another, and so that the compressed air in all the vessels can be released by a single turbo expander and generator set, an underground pipe or tube is preferably provided that extends between the stations and towers, such that compressed air can flow from one vessel to the other, and from one tower to the other, and be released at the appropriate time.

One of the advantages of the wind turbine station and tower of the present invention is that the builder of the facility can avoid the high cost of having to construct both a separate tower and a separate storage tank for storing compressed air, wherein in current practice, the cost of the tower itself can be more than fifty percent of the total cost of the station. This way, the cost of separately providing the tower and storage tank can be eliminated, thereby making these systems more cost-effective to install.

Another advantage is that the height of the wind turbine blades can be increased substantially by creating a strengthened tower that can better resist the wind forces and resulting bending moment forces that can be applied to the top of the tower as the wind engages the turbine blades at higher elevations. This not only allows the turbine blades to be situated higher to access greater wind speeds, and therefore, achieve increased efficiencies, but also enables the wind turbine stations to be provided with greater storage capacities and located closer to potential upwind obstructions, i.e., by allowing the blades to be positioned above the height of the obstruction, it becomes possible to locate the tower closer to the obstruction.

Being able to build towers higher also enables adjacent wind towers to be built closer together, wherein the height of one can be offset from another, so they don't interfere with each other. In this respect, the swept area of the turbine blades determines the torque and power output of the stations, and must be a certain distance above and/or away from other wind turbine stations or other upwind obstructions to ensure that the airfoil cross section of the rotor blades receives the laminar flow required for the maximum torque output.

### BRIEF DESCRIPTION OF THE DRAWINGS

FIG. 1 is an elevation view of a wind turbine station and tower of the present invention wherein the tower comprises two vertically oriented tanks or vessels extending upward in which compressed air can be stored, wherein a generator is located in the nacelle to produce electricity which is transmitted down to a compressor located on the ground, wherein the compressor is used to produce compressed air energy which can be stored in the tanks or vessels, wherein the compressed air can be released with a turbo expander and generator set to produce electricity;

FIG. 2 is an elevation view of another embodiment of the wind turbine station and tower of the present invention wherein the tower comprises two similar vertically oriented tanks or vessels extending upward in which compressed air can be stored, wherein a compressor is located in the nacelle and used to produce compressed air energy, which can be stored in the tanks or vessels, wherein the compressed air can then be released with a turbo expander and generator set located on the ground to produce electricity;

FIG. 3 is a cross section of the preferred embodiment of the wind turbine station and tower of the present invention, wherein the tower comprises two vertically oriented tanks or vessels extending upward in which compressed air can be stored, wherein between the two tanks or vessels a web support made of steel is provided to increase the tower's flexural strength, rigidity and moment resistance;

FIG. 4 is a cross section of an alternate embodiment of the wind turbine station and tower of the present invention wherein the tower comprises four vertically oriented tanks or vessels extending upward, with one vessel extended forward, and three vessels extended rearward perpendicularly to the forward and rearward direction of the wind turbine blade's axis, wherein between the front vessel and the middle rearward vessel, and between each vessel along the rear, a web support is provided to increase the tower's flexural strength, rigidity and moment resistance;

FIG. 5 is a cross section of an alternate embodiment of the wind turbine station and tower of the present invention wherein the tower comprises three vertically oriented tanks or vessels positioned in a triangular manner, wherein between each tank or vessel a web support made of steel is provided to increase the tower's flexural strength, rigidity and moment resistance in multiple directions;

FIG. 6 is a cross section of a wind turbine station and tower of the present invention wherein the tower comprises four vertically oriented tanks or vessels extending upward in which compressed air can be stored, wherein the tanks or vessels form a square, rectangular or diamond shaped configuration from above, and between each of the four vessels a web support made of steel is provided to increase the tower's flexural strength, rigidity and moment resistance in multiple directions;

FIG. 7 is a detailed cross section of a wind turbine tower of the present invention wherein the tower comprises two vertically oriented tanks or vessels extending upward, wherein between the two tanks or vessels a web support made of steel is provided to increase the tower's flexural strength, rigidity and moment resistance, with the horizontal axis of the wind turbine blades shown in the center as a dashed line;

FIG. 8 is an elevation view of an embodiment of the wind turbine station and tower of the present invention wherein multiple towers are provided, wherein the compressor for each tower is located in the nacelle of the wind turbine station, and wherein an underground pipe or tube is provided to connect the tanks or vessels together, such that a single turbo expander and generator set located on the ground can be used to release the compressed air stored in the multiple tanks and vessels to produce electricity;

FIG. 9 is an elevation view of an alternate embodiment of the wind turbine station and tower of the present invention wherein multiple towers are provided, wherein a compressor is located on the ground next to each tower, and an underground pipe or tube is provided to connect the tanks or vessels together, such that a single turbo expander and generator set located on the ground can be driven by the compressed air energy stored in the multiple tanks or vessels and used to produce electricity;

FIG. 10 is a schematic view of the nacelle and a cross section view of an embodiment of the tower of the present invention showing the nacelle and the location of the compressor and generator and other components within;

FIG. 11 is a detail showing the bottom end of the wind turbine tower of the present invention showing how water that collects within the vessels can be extracted out through a valve; and

FIG. 12 is a schematic view of an alternate embodiment showing the nacelle and the location of the compressor and generator and other components within, wherein the generator and compressor are geared on either side of the turbine blade drive shaft, such that by engaging the appropriate gears on either side, the appropriate conversion device can be activated and used.

### DETAILED DESCRIPTION OF THE INVENTION

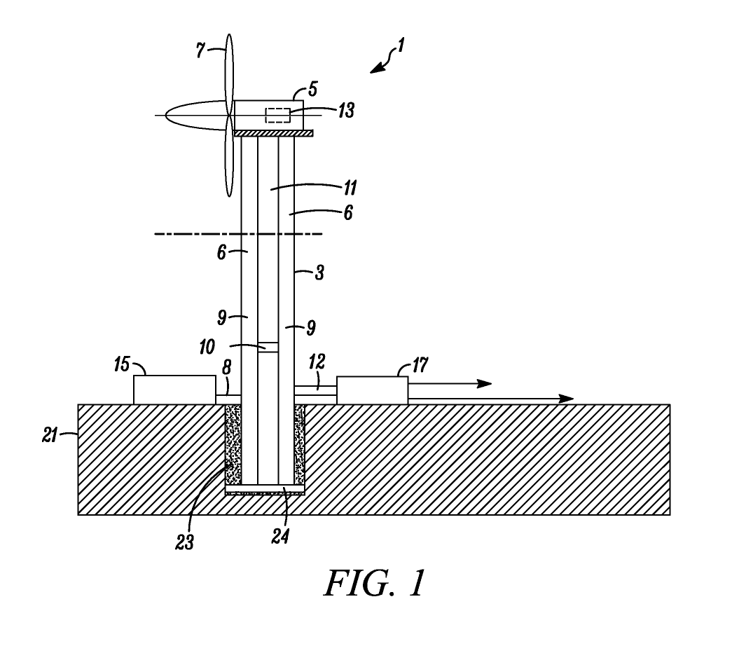

FIG. 1 shows a wind turbine station 1 and tower 3 of the present invention wherein a wind turbine drive mechanism is located inside a nacelle 5 located on top of tower 3, and wind turbine blades 7 are connected thereto and allowed to rotate. Tower 3 preferably comprises two large vertically oriented storage tanks or vessels 9, which are extended upward from the ground, and which serve to not only support the wind turbine blades 7 high in the air, but also to provide storage volume space for the compressed air energy produced by station 1.

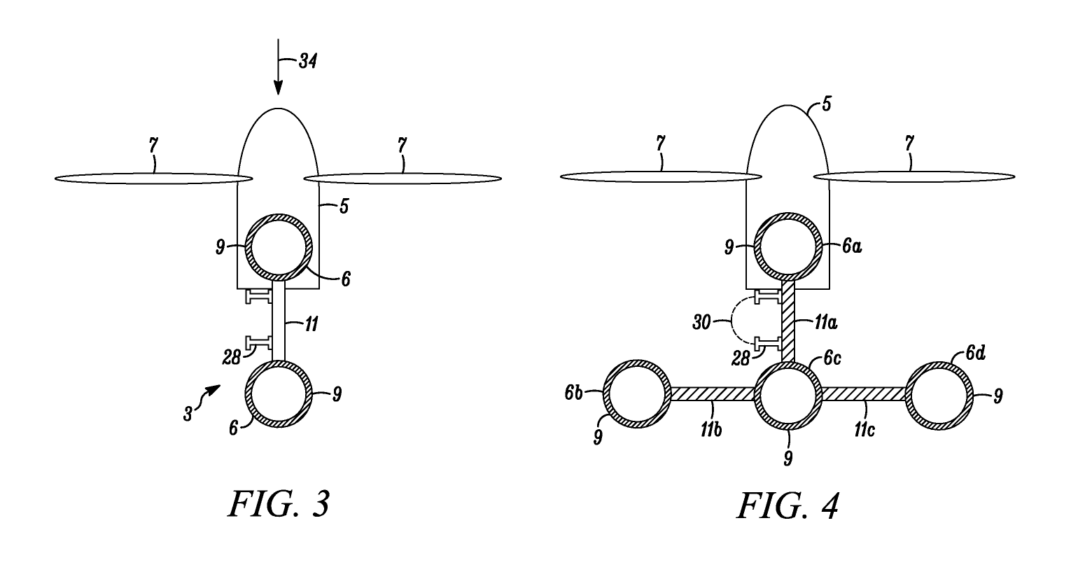

In the preferred embodiment, at least two vertically oriented tanks or vessels 9, extended parallel to one another, with their longitudinal axis extending substantially vertical, are provided and installed per tower 3, although not necessarily so, i.e., a tower 3 can have one tank or vessel 9, but preferably two or more tanks or vessels 9, as will be discussed. Preferably, as shown in the cross section drawing of FIG. 3, two tanks or vessels 9 are provided in close proximity to each other, but connected together by a thick steel web 11, wherein web 11 is welded and extended between the two tanks or vessels 9 to increase the tower's flexural strength, rigidity and moment resistance, including shear strength, against wind forces applied laterally against the top of tower 3.

Within each tower 3, tanks or vessels 9 preferably have means for communicating with each other, such that the compressed air can pass between multiple tanks or vessels 9. For example, a tube or other passage 10 is preferably extended between tanks or vessels 9 so that compressed air can pass from one tank or vessel 9 to the other such, wherein the pressure inside both tanks or vessels 9 can be maintained in substantial equilibrium.

In the embodiment shown in FIG. 1, an electrical generator 13 is preferably located in nacelle 5 such that as the wind blows and wind turbine blades 7 rotate, they drive generator 13 to produce electricity. The electricity is then transmitted down tower 3 via at least one electrical cable or line (not shown) extending down from nacelle 5 to the ground where a compressor 15 is located, wherein the electricity can be used to drive compressor 15. This in turn, produces compressed air energy for storage in tanks or vessels 9, which passes through tube 8. This embodiment is particularly useful in cases where a wind farm is installed having three or more wind turbine stations, and the electrical power from the wind turbines are combined to drive a single large compressor located on the ground, so that the cost of heat recovery and efficiency relative to the compressor is increased. In this respect, consideration should be given to splitting the air compression chore among separate smaller compressors (large, medium and small) so that all compressors are activated when the design wind energy is available, but only the smallest compressor is activated when the available wind energy is relatively small.

Another cable (not shown) can be extended from generator 13 down such that electricity generated by station 1 can be transmitted directly to an end user or grid, such that it can be used immediately without storing the energy first. Using the electricity without storing it first results in more efficiency since there is normally a fair amount of energy loss resulting from converting energy from electricity to compressed air and then back again. In such case, a switching mechanism is preferably provided that enables the energy output to be switched between electricity generated by generator 13 for immediate use and transmitting the electricity produced by generator 13 to drive compressor 15 for purposes of storing the compressed air in tanks or vessels 9. Whether the switch is set to one position or the other will depend on a number of factors, including whether more energy is needed immediately, or whether there is excess energy available for storage, which can be a function of the supply and demand curves for the site.

As shown in FIG. 1, a turbo expander and generator set 17 is preferably located on the ground somewhere adjacent to or near tower 3, which can be used to release the compressed air stored in tanks or vessels 9, such as through tube 12, and used to drive generator 13 to generate electricity. That way, extra electricity can be generated during peak demand periods, or whenever energy demand exceeds supply, and this can be done by releasing the compressed air stored in tanks or vessels 9 using the turbo expander and generator set 17. This allows more energy to be produced during high demand periods or when there is otherwise less energy available than is being generated by the wind. Likewise, the chilled air co-generated by turbo expander 17 as the compressed air is released can be used for ancillary purposes, such refrigeration, operating an HVAC unit, desalination and the like.

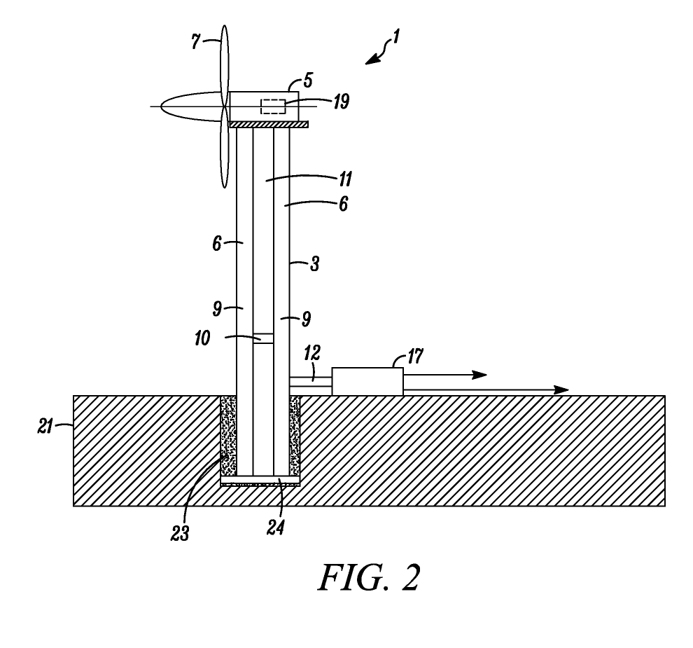

The embodiment shown in FIG. 2 is similar to the embodiment of FIG. 1 except a compressor 19 is built into the nacelle 5 to generate compressed air energy directly from the rotational energy produced as the wind acts on blades 7, rather than producing electricity using a generator 13. This embodiment has some of the same components as the one shown in FIG. 1, namely, a tower 3, nacelle 5, wind turbine blades 7, tanks or vessels 9, web section 11, and turbo expander and generator set 17, except it has no separate generator 13. Compressor 19 preferably has a gear box that converts the rotor vane speed from blades 7 and steps it up to the required compressor rotational speed. Preferably, compressor 19 will deliver compressed air energy to tanks or vessels 9 no matter what the compressor rotational speed is. This is one advantage that the mechanical drive has over an electric motor drive. When the wind blows, compressor 19 will feed compressed air into and pressurize tanks or vessels 9.

Having a compressor 19 in nacelle 5 avoids the need to convert mechanical power into electricity before compressing the air, i.e., power is not lost by having to convert it from the mechanical wind power to electrical power to drive the compressor. This arrangement preferably reduces the energy losses normally attributed to the following conversions: 1) from wind energy to electricity, 2) from electricity to compressed air energy, and 3) from compressed air energy back to electricity again.

The mechanical energy produced by the rotational movement of blades 7 directly powers compressor 19 and this produces compressed air energy which is then stored in tanks or vessels 9. The compressed air can then be released at the appropriate time and converted into electricity without having to convert the mechanical energy to electricity first. Accordingly, this embodiment does not need an electrical generator 13 for producing electricity before compressing the air, as in the previous embodiment, insofar as the mechanical energy directly produces compressed air energy which is then stored.

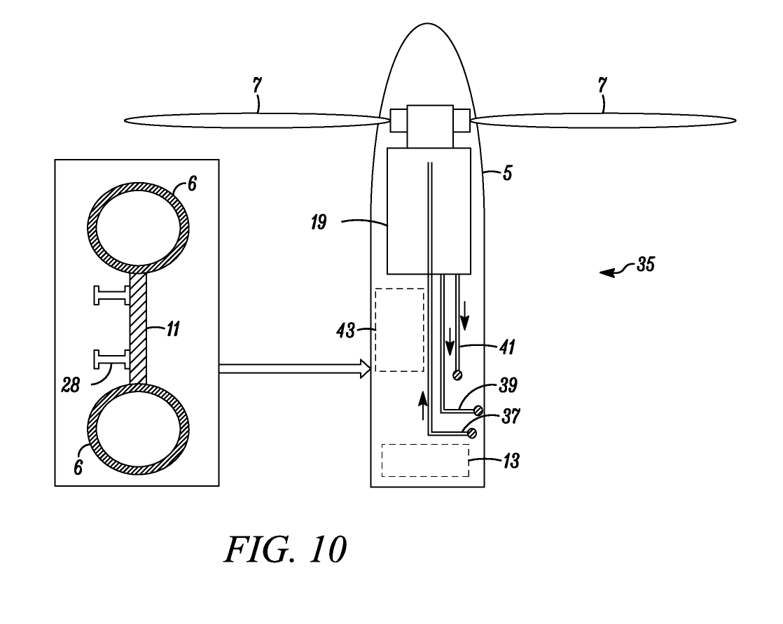

At the same time, as shown in FIG. 10, it is possible to have both a compressor 19 and generator 13 located in nacelle 5 such that station 1 can be switched between providing compressed air energy, on one hand, and providing electrical energy, on the other hand, i.e., it can be a hybrid station. The compressor 19 in such case will operate efficiently to convert mechanical wind energy into compressed air energy for storage in tanks or vessels 9, while generator 13 will work separately and alternatively to convert mechanical wind energy directly into electricity, which can then be used to provide electrical energy immediately to the end user or grid, etc. In such case, a switching mechanism preferably allows station 1 to be switched to the appropriate position when the need arises. When supply exceeds demand, for example, the switch can be used so compressor 19 can generate compressed air energy into storage, whereas, when demand exceeds supply, the switch can be used to cause generator 13 to operate and produce electricity directly to the end user or grid.

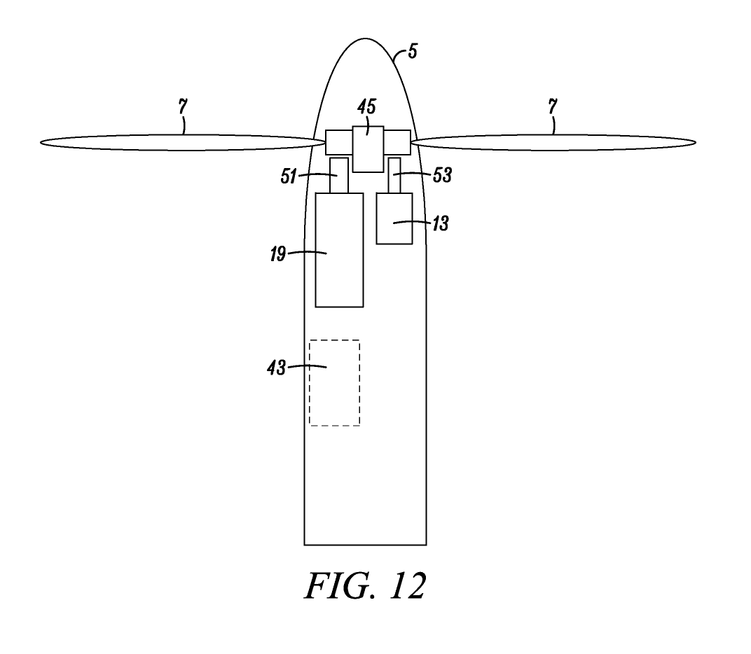

In another embodiment, as shown in FIG. 12, a control system is preferably provided which enables the extent to which energy is converted into storage via compressor 51 and/or converted into electricity via generator 53 can be adjusted, based on the supply and demand cycles of the system. For example, rather than a switch that allows the system to produce either electricity or compressed air, both can be produced at the same time in various amounts, depending on the needs of the system. In one scenario, this embodiment can be set so that at least some of the wind energy is always converted into electricity first, wherein any excess energy not needed by the grid or end user can be used to drive the compressor to produce compressed air energy which can then be placed into storage. In such case, a mechanism that determines when electricity is in excess and when it is not is preferably provided, wherein, in the case of a large wind farm with multiple wind turbine stations, the system is able to know what amount of energy should go into storage and what amount should be distributed to the end user or grid, and this can be determined with respect to each wind turbine station. This applies in the case of a single wind turbine station or a wind farm composed of multiple wind turbines stations.

In either case, tower 3 is preferably configured and constructed in the following manner: In the embodiment of FIGS. 1-2, tanks or vessels 9 are preferably constructed using two large diameter steel pipes 6 that are extended into the ground 21 and substantially vertically oriented and extended upward with their axis extending substantially vertically. Preferably, a significant portion of each pipe 6 is buried under ground 21 so that the ground material such as concrete can serve as a thermal conductor. Up to about fifty percent of each pipe 6 can be extended into the ground 21, although the preferred amount is more like about one sixth to about one third, which enables tower 3 to be made taller. For example, if pipes 6 are each 250 feet long, preferably, anywhere from 40 to 80 feet can be in the ground, and anywhere from 210 to 170 feet of pipe, respectively, can be extended above ground, which in turn, means that wind turbine blades 7 can be located at 170 to 210 feet above ground. The height or length of tower 3, and therefore, pipes 6, can also be a function of the desired volume of storage space needed in tanks or vessels 9 for any given application.

With pipes 6 partially buried in ground 21, a predetermined conductive material 23 such as concrete preferably surrounds the bottom of each pipe 6, so that the hot and cold temperatures that may result as compressed air is being injected and released, respectively, can be dissipated into ground 21 by the surrounding material 23. In this respect, an increase in temperature can occur as compressed air is introduced into tanks or vessels 9 through compressor 15 or 19, or a drop in temperature can occur within tanks or vessels 9 as the mass of compressed air is released by the turbo expander and generator set 17, which will lower the air mass density. Each tank or vessel 9 preferably comprises 1) a thermal conductivity zone that extends from the bottom of each pipe 6 to about ground level, and 2) a regular conductivity zone that extends from about ground level to the top of tower 3. The thermal conductivity zone preferably has conductive material such as concrete 23 surrounding the lower portion of pipes 6 to enable warmer or colder air temperatures created within tanks or vessels 9 to be distributed into ground 21 and dissipated more rapidly. This helps to regulate and control the temperature of the air inside tanks or vessels 9, including the regular conductivity zone. The thickness of the walls of tanks or vessels 9 can also help control the temperature of the air inside. A support or bearing structure 24 is preferably provided at the bottom of pipes 6 to provide support for tower 3. The top and bottom ends of pipe 6 are preferably rounded to ensure even distribution of pressure against the walls of pipe 6, wherein nacelle 5 and support structure 24 are preferably adapted to take into account this variation in shape.

Preferably, the diameter of pipes 6 used in the towers can range from about two feet to about four feet or more, with a preferred diameter being about three feet, depending on the amount of desired storage space needed, as well as the thermal capacity needed to control the temperature of the air within tanks or vessels 9. The thickness of the walls is preferably determined based on the maximum amount of pressure to be expected within tanks or vessels 9 as well as the amount of bending forces to be expected due to wind forces being applied against the top of tower 3, which can result in extra compression and tensile forces being applied to the walls of pipes 6. The thickness of the walls of tanks or vessels 9 and web 11 are also dependent on the amount of thermal capacity that needs to be provided to regulate and control the temperature of the air inside, and the strength needed to support the weight of tower 3. Web 11 can be provided with a ladder 28 and safety cage 30, as shown in FIG. 4, to enable workers to access the top of tower 3. An elevator can also be provided (not shown) to provide access to nacelle 5.

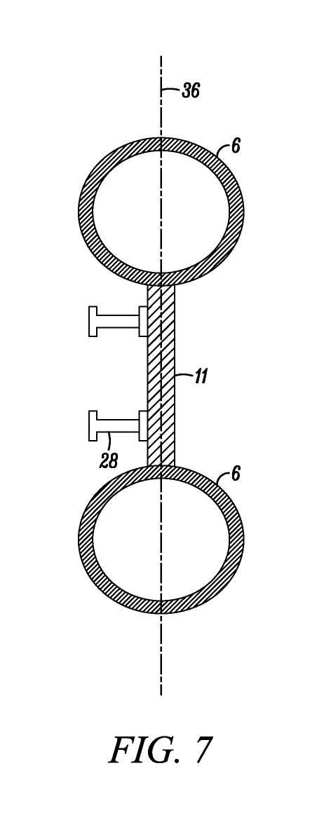

In the embodiments of FIGS. 1 to 3, two tanks or vessels 9 (or pipes 6) are preferably extended upward and oriented parallel to each other so that their vertical axis intersects the horizontal axis of the center of the wind turbine blades 7, such as shown in FIGS. 3 and 7. This configuration improves the flexural strength, rigidity and moment resistance of tower 3 relative to the direction that the wind would blow against blades 7, which are typically aimed toward the wind (see arrow 34 representing the direction of the wind shown in FIG. 3), wherein the lateral forces that are applied against the top of tower 3 typically coincide with the wind direction and horizontal axis of blades 7, wherein tower 3 is preferably built to withstand the maximum bending forces that could be applied in that direction—along axis 36 in FIG. 7. Having multiple tanks or vessels 9 serves the purpose of increasing the tower's flexural strength and rigidity and moment resistance to further resist the lateral forces that can be applied against the top of tower 3.

As shown in FIG. 3, steel web 11 is preferably connected to and extends between pipes 6, such as by welding or other means, forming a single unified structure with upper and lower flanges resistant to bending. Web 11 is preferably connected to and extended between two tanks or vessels 9 to reinforce the tower's flexural strength, rigidity and moment resistance, and by resisting the shear forces that can be experienced between the two pipes 6. In this respect, it can be seen that pipes 6 resemble upper and lower flanges having a web 11 in between them. That way, the compression and tensile forces resulting from the lateral wind forces applied against the top of tower 3, along with the shear forces that result from those forces being applied, can be taken into account and the structure of tower 3 will be able to resist the bending forces applied to tower 3.

The increased flexural strength, rigidity and moment resistance of tower 3 enables tower 3 to be built higher, which makes the overall system more efficient. For example, using the same wind turbine, a 200 feet tower could potentially produce as much as five times more energy/power than a 60 feet tower, since greater wind speeds are typically encountered at higher elevations above ground. Enabling blades 7 to be located higher also has the advantage of increasing the storage capacity of each tower, and eliminating the deleterious effects of tall upstream obstacles, such as adjacent trees and hills, including other wind turbine stations.

By having increased flexural strength and rigidity and moment resistance, tower 3 can be built to withstand greater wind forces and therefore it can be built even taller, thereby accessing higher wind speeds using the same wind turbine, and increasing the efficiency of the wind turbine design. Accessing greater wind speeds will also enable the power output levels of the components used in the system to be scaled upward, including the compressor 15 or 19, which can advantageously make the entire system run more efficiently in terms of the cost to produce a single unit of energy output. For example, a 2,000 kW wind turbine station with a 1,200 psi compressor might be able to produce energy at a cost per unit that is less than one third the cost of producing energy using a 30 kW wind turbine station with a 1,200 psi compressor.

Larger installations also permit more airflow to be brought to the same high final pressure, and large compressors, such as centrifugal compressors, often have variable drive mechanisms that can be operated at lower torque levels, such as those produced with lower wind speeds, whereas, small compressors, such as piston air compressors, normally operate only at a predetermined torque. In the latter case, multiple smaller compressors are often required, wherein each of them may only operate at lower levels. Although variable drive technologies are more efficient and can deliver more power more consistently, the upfront cost of installing them can be substantially higher, and they can be more delicate to operate and maintain. All of these considerations should be taken into account when choosing which compressor to install.

While in the embodiments of FIGS. 1 to 3, tower 3 is preferably comprised of two tanks or vessels 9 each, embodiments having more than two tanks or vessels 9, such as shown in FIGS. 4 to 6, including three or four tanks or vessels 9 per tower, are contemplated. Virtually any number of tanks or vessels 9 that will serve the intended purposes—to place the wind turbine blades 7 high enough (where the wind naturally blows at greater velocities), while at the same time, providing adequate storage for the compressed air energy produced by the station—can be selected and used.

The embodiments of FIGS. 4 to 6 comprise towers 3 with more than two tanks or vessels 9 each (more than two pipes 6), to provide not only more storage space for storing more compressed air energy, but also additional degrees of flexural strength and rigidity and moment resistance, which can enable tower 3 to be built higher. Not only will providing more pipes 6 increase the strength of tower 3 overall, but having more pipes 6 positioned in different locations along different axis can also increase the tower's ability to resist bending in more than one direction—more than just the direction that the wind normally blows, which is normally the same direction as the horizontal axis 36 of blades 7.

FIG. 4, for example, shows an alternate embodiment having four vertically oriented pressure tanks or vessels 9 forming a substantial T configuration from above for storing compressed air energy, wherein a first pipe 6a has a vertical axis extended through or near the front of nacelle 5 and through or substantially near the horizontal axis 36 of blades 7 (as shown in FIG. 7). The other three pipes, 6b, 6c, and 6d, are preferably extended along the back, along a line perpendicular to the horizontal axis of wind turbine blades 7, wherein the middle pipe 6c preferably has its vertical axis extended through or near the horizontal axis of blades 7, and pipes 6b and 6d are preferably positioned on either side, with their vertical axis equidistant from the vertical axis of pipe 6c and horizontal axis 36.

Web 11a strengthens tower 3 and preferably extends between pipe 6a and pipe 6c. Additional webs 11b and 11c are preferably extended respectively between pipes 6b and 6c, and pipes 6c and 6d, wherein webs 11b and 11c are preferably extended along a plane that is perpendicular to the plane of web 11a, thereby forming a T configuration from above—in plan view as shown in FIG. 4. Again, a ladder 28 and safety cage 30 or elevator (not shown) can be provided on one or more of the webs, either 11a, 11b, or 11c.

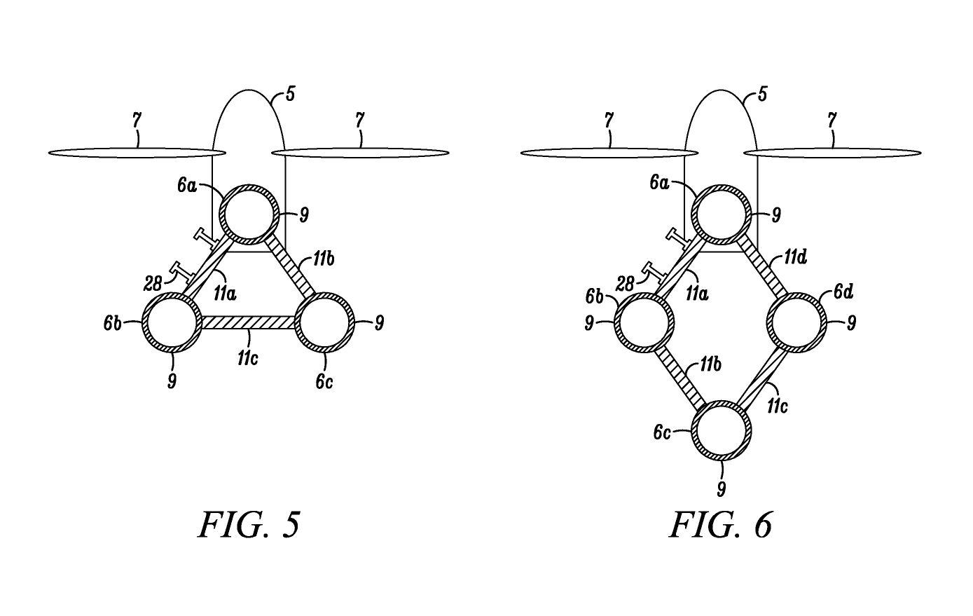

FIG. 5 shows an alternate embodiment having three vertically oriented pressure tanks or vessels 9 for storing compressed air energy, wherein a first pipe 6a has its vertical axis extended through or near the horizontal axis of blades 7, as well as through or near the front end of nacelle 5 (relative to the front and back direction that extends along the horizontal axis of wind turbine blades 7), while the other two pipes, 6b and 6c, are extended further behind, preferably with their vertical axis equidistant from pipe 6a, on either side of horizontal axis 36 of blades 7, forming a triangular configuration in plan view from above, as shown in FIG. 5.

A separate web section is preferably provided between each pipe, i.e., web 11a is extended between pipes 6a and 6b, web 11b is extended between pipes 6a and 6c, and web 11c is extended between pipes 6b and 6c. Again, ladder 28 and safety cage 30 or elevator (not shown) can be provided on one or more webs, 11a, 11b, or 11c.

FIG. 6 shows an alternate embodiment having four vertically oriented tanks or vessels 9 in a square, rectangle or diamond shape, for storing compressed air energy, wherein a first pipe 6a is extended with its vertical axis intersecting the horizontal axis 36 of blades 7, as well as the front of nacelle 5 (relative to the front and back direction that extends along the horizontal axis of wind turbine blades 7), while the other three pipes, 6b, 6c, and 6d, are extended further behind, forming a diamond shape from above, as shown in FIG. 6. A separate web section is preferably provided between each pipe extending around the exterior, i.e., web 11a is extended between pipes 6a and 6b, web 11b is extended between pipes 6b and 6c, web 11c is extended between pipes 6c and 6d, and web 11d is extended between pipes 6d and 6a. Again, ladder 28 and safety cage 30 or elevator (not shown) can be provided on one or more of the webs, 11a, 11b, 11c or 11d.

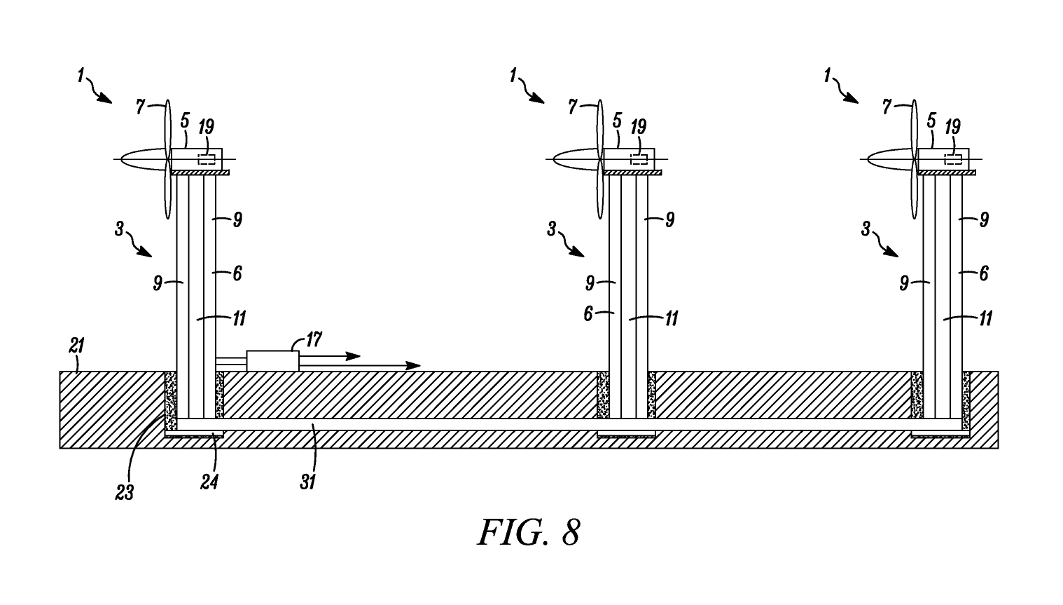

FIG. 8 shows a wind farm having three wind turbine stations 1 similar to those shown in FIG. 2, where each station has a tower 3 consisting of two vertically oriented tanks or vessels 9, with a web 11 between each of them, and a nacelle 5 on top, and wind turbine blades 7. In this embodiment, each station 1 preferably has a compressor 19 built into nacelle 5 to generate compressed air energy directly from the rotational energy produced as the wind acts on blades 7, wherein the compressed air energy can be stored directly within tanks or vessels 9. Because each station 1 has its own compressor 19 and its own storage tanks or vessels 9, compressed air generated by compressor 19 can be immediately injected into tanks or vessels 9 located within the same tower.

This is an example of a wind farm comprising three stations 1, but other wind farms comprising any number of wind turbine stations 1 are within the contemplation of the invention. The determination as to how many wind turbine stations should be provided in any given application is a function of many factors, including the demand for energy, and how much energy is needed for storage, etc.

In the embodiment of FIG. 8, for efficiency purposes, only a single turbo expander and generator set 17 is provided in conjunction with all three wind turbine stations 1. And to enable the compressed air energy from all three stations to be converted by the turbo expander and generator set 17, one or more ancillary pipes or tubes 31 capable of transmitting the compressed air energy from one station 1 to the other (or one tower 3 to the other) is preferably provided. Pipe or tube 31 can be similar in construction to the other pipes 6 used in towers 3, such that they can store compressed air energy as well as transmit it, or it can be configured and sized independently as needed to enable a sufficient flow of compressed air between tanks or vessels 9 in multiple stations 1. A preferred location for pipe 31 is underground beneath towers 3, wherein it can be connected to each tower 3 and allow communication between multiple pipes 6.

The distance between stations and the length of pipe 31 and the amount of desired storage space needed within tanks or vessels 9 and pipe 31 can be considered when designing the wind farm including the number of stations to be used and where they should be located, etc. Although any number of wind turbine stations 1 can be connected to a single turbo expander and generator set 17, a determination should be made in connection with each wind farm to determine how many towers 3 and how many tanks or vessels 9 should be connected to each turbo expander and generator set 17. This is normally a function of the amount of energy needed to be produced by the wind farm, based on demand, and how much energy can be generated by the wind turbines, and how much storage space is required for any given application, but this should also be based on how many towers 3 and tanks or vessels 9 should be used in connection with a single turbo expander and generator set 17 to achieve the greatest efficiency. This last determination will often be a function of the amount of compressed air energy stored and used at any given time, and how efficiently the turbo expander and generator set 17 can be operated in connection with the size and number of tanks or vessels 9 involved, which determines the volume of compressed air that will need to be stored, wherein the goal is to optimize the efficiency of converting the compressed air energy into electricity, based on the rating of the turbo expander and generator set 17.

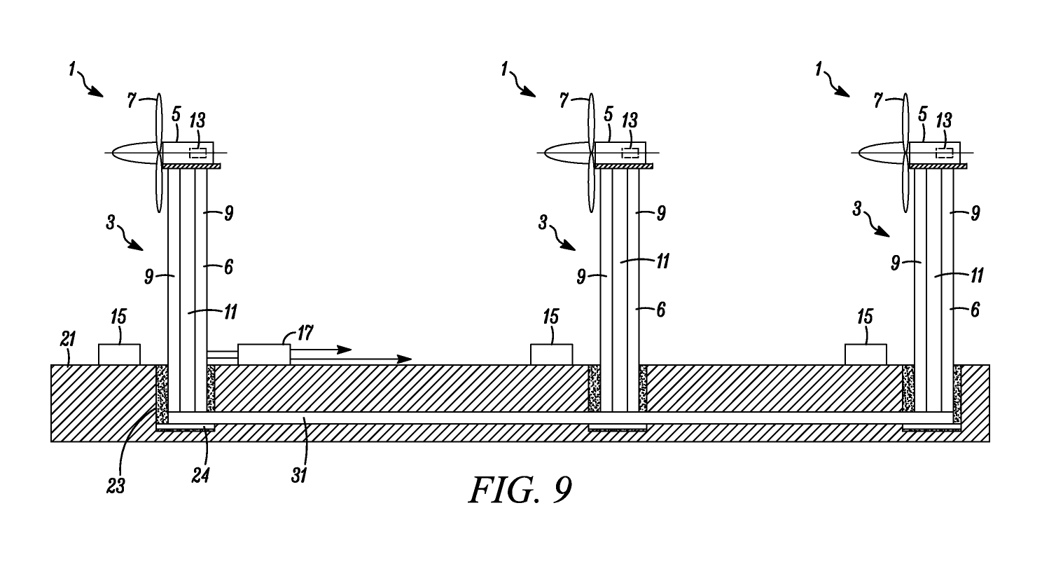

FIG. 9 shows an alternate wind farm having three wind turbine stations 1 similar to those shown in FIG. 8, except that in this case, the wind turbine stations 1 are like those shown in FIG. 1, wherein the compressor 15 is located on the ground, rather than in nacelle 5, while a separate electrical generator 13 is built into each nacelle 5. Thus, in this embodiment, the rotational energy produced as the wind acts on blades 7 is converted into electricity first, using generator 13, wherein the electricity is then transmitted down and used immediately to drive compressor 15 to produce compressed air energy that can be stored in vessels 9. And, like the embodiment of FIG. 1, each wind turbine station 1 can be equipped with a switching mechanism to enable the electricity transmitted to be used for storage or immediate use, etc., like a hybrid station. Because each station 1 has its own generator 13 and compressor 15, compressed air generated by tower 3 can be injected into tanks or vessels 9. Again, wind farms comprising any number of wind turbine stations 1 of this type are within the contemplation of the invention.

FIG. 10 shows a hybrid station 35 that has both a compressor 19 and generator 13 in the same nacelle 5. Compressor 19 is preferably a water cooled multi-stage compressor with heat exchangers for controlling the temperature of the input air introduced into tanks or vessels 9. Cold water is preferably drawn from an exterior source and introduced through input pipe 37 and into compressor 19, where the cold water helps to reduce the temperature of the compressed air while it is being pressurized and pumped. Heated water resulting from the heat exchange process is then drawn out of compressor 19, and out through output pipe 39, wherein condensed water that forms as the moisture condenses from the air is drawn from compressor 19 and out through output pipe 41. A trap door 43 is shown. Compressor 15 can be constructed the same. Electric generator 13 can be provided within nacelle 5 which can be operated by the rotation of the wind turbine blades 7. As electrical energy is produced thereby, it can be distributed down tower 3 via a cable or line (not shown), to an end user or grid, etc. A switch preferably allows station 35 to be alternated between providing compressed air energy into storage, on one hand, and producing electricity for immediate use, on the other hand. This way, hybrid station 35 can be adapted to provide energy in a form that is most needed in connection with the demand and supply curves at any given site.

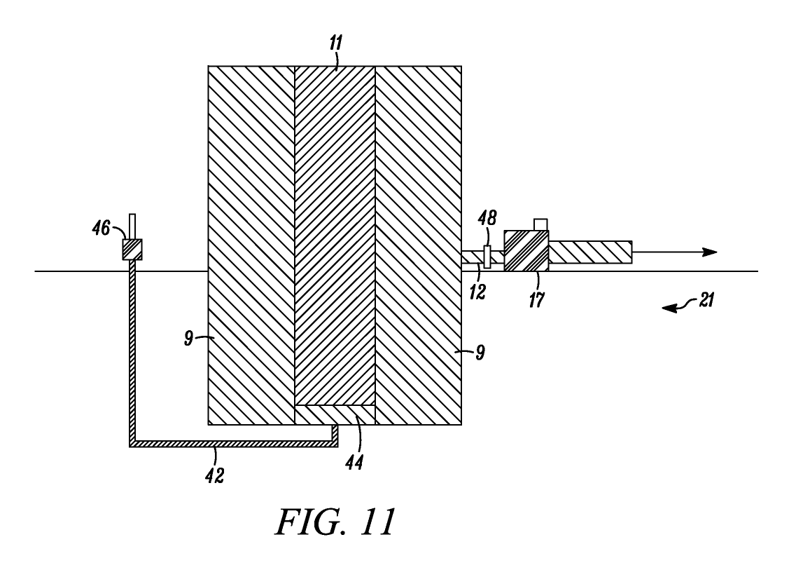

FIG. 11 shows the bottom end of tower 3 with tanks or vessels 9 extended into ground 21, wherein a drain 44 and valve 46 are provided at the lower end to enable water that would otherwise collect at the bottom of tanks or vessels 9 to be removed. Although most of the moisture from the air condenses and can be removed with compressor 15 or 19, inevitably, some water will collect at the bottom that will have to be removed to avoid causing the steel to rust and corrode, as well as reducing the volume of space within tanks or vessels 9. Valve 46 helps to maintain the pressure of the compressed air within tanks or vessels 9 when it is closed, but preferably, allows water at the bottom of tanks or vessels 9 to be released as a result of the internal pressure within tanks or vessels 9. Because it is desirable to keep at least 200 psig inside tanks or vessels 9, it can be seen that simply opening valve 46 will cause water to vent. Once the water is removed, valve 46 can be closed to enable pressure inside vessels 9 to build back up.

FIG. 11 shows turbo expander and generator set 17 located on the ground with a separate valve 48 that controls the flow of compressed air out of tanks or vessels 9 through tube 12, which is preferably located well above the level of water collecting in tanks or vessels 9. Because most of the moisture has been removed from the air using compressors 15 or 19, the output air that is introduced into turbo expander and generator set 17 is relatively free of moisture, which advantageously reduces the problems associated with releasing and expanding the compressed air within tanks or vessels 9. In such case, when the compressed air is released and expanded, and the temperature of the air is reduced, very few if any ice particles are formed, thereby helping to avoid further problems. And because the temperature of the air is reduced, a by-product of generating electricity is the formation of super-chilled air, which can be used for other purposes.

FIG. 12 shows an embodiment having a nacelle 5 and blades 7 wherein the turbine driver 45 is comprised of gears that are adapted to mesh with gears on an electric generator 53 and/or compressor 51 that are positioned on either side of driver 45. By engaging the gears on one side or the other, or both, the wind energy that causes blades 7 to rotate will be transferred to the appropriate energy converting device via the gears. For example, when the driver's gears are meshed with the gears of generator 53, generator 53 will produce electricity, whereas, when the driver's gears are meshed with the gears of compressor 51, compressor 51 will produce compressed air energy. The gears on both generator 53 and compressor 51 can be meshed at the same time to enable both devices to operate simultaneously. In either case, the electricity generated by generator 53 is preferably distributed to a grid or end user wherein the energy can be used immediately, and/or the extra compressed air energy can be fed into tanks or vessels 9 and stored for later use as discussed above.

In this embodiment, a control system is preferably provided which enables the extent to which energy is converted into storage via compressor 51 and/or converted into electricity via generator 53 can be adjusted, based on the supply and demand cycles imposed on the system. For example, in one scenario, this embodiment can be set so that at least some of the wind energy is always converted into electricity first, to supply power to the grid or end user continuously, wherein any excess energy not needed by the grid or end user can then be used to drive the compressor to produce compressed air energy that can be stored.

In such case, a mechanism that determines when electricity is in excess and when it is not is preferably provided, wherein, in the case of a large wind farm with multiple wind turbine stations, the system is able to know what amount of energy should go into storage and what amount should be distributed to the end user or grid, and this can be determined with respect to each wind turbine station, wherein such a determination is preferably made system-wide based on the total demand imposed on the wind farm. In such case, a servo-mechanism in the control box preferably receives power demand signals and information from the end user or grid, such as in the form of power demand histories in 15 minute intervals during a period of the past 3 days, as an example. It also preferably predicts the power demand requirements on the system for an upcoming period of time, while taking into account the instantaneous wind turbine power production output levels. This applies in the case of a single wind turbine station or a wind farm composed of multiple stations wherein some are more active than others.

In either case there can be inflow of information from the following:

(1) The “end user” or “grid” can provide information regarding the real time power demand continuously exerted on the system, which can be supplied in short time intervals, such as every 15 minutes. It can also comprise data collected over a predetermined time, such as over the previous 3 day period, again, as an example.

(2) A prediction is preferably made available based on the local wind history data provided for the site that is accurate for a predetermined amount of time.

(3) Generator 53 is preferably assigned a higher priority than compressor 51 such that generator 53 will mesh with turbine driver 45 before compressor 51 will mesh with driver 45, such that electricity will be generated in sufficient amounts before excess energy will be stored.

(4) When the logic circuit of the control system identifies that there is sufficient wind power to supply both generator 53 and compressor 51, to produce both electricity and compressed air energy, both converting devices are preferably adapted so that they will mesh with the gears on turbine driver 45, so that both electricity and compressed air energy can be produced simultaneously. In this respect, the gears are preferably adapted so that the system provides a sufficient level of flexibility in distributing the appropriate amount of power to compressor 51 and/or generator 53. For example, the gears can be set so that the generator may receive increments of 100%, 80%, 60%, 40%, 20% or 0% of the wind power available from the nacelle, whereas, the compressor can receive whatever energy is left. In such case, the logic circuit preferably does not permit more electricity to be sent to the end user or grid than will be in demand at any given time, since there is no way for the system to absorb the excess electricity. And if the ratio does not permit an exact match of energy between immediate use and energy storage, any difference can be made up by supplying energy from compressed air in storage.

In practice, storage tanks or vessels 9 of the present invention are preferably used to store energy whenever energy supply exceeds demand. For example, in the embodiment of FIG. 1, if the amount of electricity generated by generator 13 exceeds the demand for energy, the extra electricity can be used to drive compressor 15, which in turn, can produce compressed air energy that can be stored in tanks or vessels 9. This can occur when the wind is blowing hard, and/or when there is little demand for energy, wherein in either case, the excess energy can be stored. It is desirable to maintain at least 200 psi inside tanks or vessels 9 at all times and the pressure can be increased to 1,200 psi or possibly more, although greater pressures will require stronger tanks.

Then, when demand exceeds available source energy, the compressed air energy in storage can be used to supply supplemental energy to the end user or grid, etc. This can be accomplished by releasing the compressed air energy from storage using the turbo expander and generator 17 to produce electricity. The cold air co-generated as the compressed air is released can then be used for ancillary purposes, such as refrigeration, air conditioning, desalination, etc. Again, a minimum pressure of at least 200 psi is preferably maintained.

Whether a station is in the energy storage or energy use mode is preferably controlled with a circuit switch which controls whether excess energy is fed into storage, or whether the stored energy is used to supplement the existing energy supply. To make that determination, the circuit preferably uses instantaneous data from one or more sensors that determine 1) the amount of pressure stored within tanks or vessels 9, 2) the amount of electric power being delivered by the wind turbine stations to the end user or grid, etc., and 3) the demand for electric power by the end user or grid, etc. Based on this data, when the criterion is met, power begins to be distributed into or out of storage, and/or is used immediately by the end user or grid, etc.

Note: In situations where small compressors are used, the system may be designed to determine whether there is sufficient wind power to drive the compressors, including whether there is only enough to drive one compressor at a time, in which case, the system can be set up so that fewer than all compressors can run at any given time. And in situations where multiple stations are used, along with a separate small compressor in each station, the system is preferably designed to determine how many small compressors can be driven at any given time, wherein, the system is preferably capable of being switched to drive only those compressors that are small enough to be driven by the available wind power supplied. If the available wind power is insufficient to drive the compressors, the compressors can be turned off, and the system can send the excess power to waste.

In connection with the features of the present invention described above, including applications where multiple wind turbine stations are constructed to create a large wind farm, it can be seen that the teachings of applicants' prior U.S. application Ser. No. 10/263,848 can be combined with the teachings of the present invention, and therefore, previous application Ser. No. 10/263,848 is incorporated herein by reference. Indeed, it can be seen that the wind turbine stations and towers of the present invention can serve as either the storage windmill stations or the hybrid windmill stations in connection with the wind farms discussed therein.

The present technology can also be used in connection with the technology described in applicants' prior U.S. application Ser. No. 10/865,865, which relates to how the compressed air energy in storage can be used to provide a limited number of substantially constant power output periods during any given 24 hour period, despite fluctuations in wind speeds, etc., and thus, U.S. application Ser. No. 10/865,865 is also incorporated herein by reference.

The present technology can also be used in connection with the various technologies described in applicants' prior U.S. application Ser. Nos. 11/585,023; 11/731,717; 12/214,137; 12/321,689; 12/587,340; and 12/930,117, and therefore, those applications are also incorporated herein by reference. For example, the chilled air co-generated by the release of compressed air from the turbo expander and generator set 17 can be used for the following purposes:

1) In connection with U.S. application Ser. No. 11/585,023, the present technology can be used in connection with a thermal energy storage system, wherein the chilled air produced by releasing the compressed air energy in storage can be used to provide chilled water in a stratified container for other purposes, such as air conditioning and the like.

2) In connection with U.S. application Ser. No. 11/731,717, the present technology can be used for desalination of seawater wherein the chilled air produced by releasing the compressed air energy in storage can be used to freeze seawater and remove salt and other impurities therefrom.

3) In connection with U.S. application Ser. No. 12/214,137, while the present technology can be used for desalination of seawater, as described above, the minerals found therein can also be removed and used for other purposes.

4) In connection with U.S. application Ser. No. 12/321,689, the present technology can be used in connection with the removal of CO2 from a coal burning power plant, using the chilled air produced by releasing the compressed air energy in storage to freeze CO2 released from the power plant, wherein the frozen CO2 can then be distributed for other purposes, such as for providing carbonation in beverages, etc.

5) In connection with U.S. application Ser. No. 12/587,340, the present technology can be used in connection with using compressed air energy to increase the efficiency of a fuel burning turbine generator, wherein the chilled air produced by releasing the compressed air in storage can be used to lower the temperature of the input air, as well as remove water particles from the input air by freezing the particles, so they don't cause damage to the turbine blades.

6) In connection with U.S. application Ser. No. 12/930,117, the present technology can be used in connection with CO2 released from a power plant, which can then be chilled using the chilled air produced by releasing the compressed air energy in storage provided by the present invention, wherein the cold liquid CO2 can then be injected into an underground rock formation containing particles of coal or gas shale, etc., to help fracture rock formations therein, and thereby release the methane gas trapped therein through adsorption.

Other uses and applications are also contemplated that are consistent with the usages described above.

What is claimed is:

1. A wind turbine station for generating energy from the wind, comprising:
a wind turbine adapted to rotate along an axis in conjunction with a nacelle;
a compressor for generating compressed air energy;
a tower for supporting said wind turbine comprising at least two substantially vertically oriented vessels, wherein said vessels comprise at least two substantially vertically oriented pipes, wherein said pipes are adapted such that compressed air energy generated by said compressor can be stored within said pipes; and
at least one web extended between and connected to said pipes, to provide rigidity and moment resistance to said tower.

2. The wind turbine station of claim 1, wherein said compressor is located inside said nacelle and is driven by the rotational movement of said wind turbine to produce compressed air energy for storage in said vessels, wherein the energy used to drive said compressor is not converted into electricity first.

3. The wind turbine station of claim 1, wherein a generator for generating electricity is located inside said nacelle and is driven by the rotational movement of said wind turbine wherein the electricity generated by said generator is used to drive said compressor and/or can be distributed to a grid or end user directly.

4. The wind turbine station of claim 3, wherein said compressor is located on the ground and is adapted to introduce compressed air energy into said vessels, and a turbo expander and generator set is provided to release the compressed air energy within said vessels to generate electricity and/or chilled air.

5. The wind turbine station of claim 1, wherein a generator for producing electricity and said compressor are located inside said nacelle and a switch mechanism is provided which allows the rotational energy produced by the wind to be switched between providing energy to drive said generator, on one hand, and/or providing energy to drive said compressor, on the other hand, wherein the extent to which one or the other is used can be switched and adjusted.

6. The wind turbine station of claim 1, wherein the axis of said wind turbine is substantially horizontal and extends substantially from the front to the back of said nacelle, wherein said pipes are oriented such that they are substantially parallel to each other, and the vertical axis of each of said pipes is extended substantially through or near said horizontal axis of said wind turbine.

7. The wind turbine station of claim 6, wherein a first of said pipes has a vertical axis extended through a front portion of said nacelle, and a second of said pipes has a vertical axis extended through a back portion of said nacelle.

8. The wind turbine station of claim 1, wherein three vertical storage pipes substantially parallel to each other with a web between them are provided and oriented such that a first of said pipes has a vertical axis extended substantially through or near a horizontal axis of said wind turbine, and a second and third of said pipes are oriented such that their vertical axis are extended substantially equidistant from said horizontal axis of said wind turbine.

9. The wind turbine station of claim 8, wherein said first of said pipes has a vertical axis extended substantially through or near a front or middle portion of said nacelle, and said second and third of said pipes are oriented such that their vertical axis are extended substantially through or near a middle or back portion of said nacelle.

10. The wind turbine station of claim 1, wherein a ladder and cage and/or elevator are provided on said web for access to the top of said tower.

11. The wind turbine station of claim 1, wherein four vertical storage pipes substantially parallel to each other with a web between them are provided and oriented such that a first and fourth of said pipes have a vertical axis extended substantially through or near a horizontal axis of said wind turbine, and a second and third of said pipes are oriented such that their vertical axis are extended substantially equidistant from said horizontal axis of said wind turbine.

12. The wind turbine station of claim 11, wherein said first of said pipes has a vertical axis extended substantially through or near a front or middle portion of said nacelle, and said fourth of said pipes has a vertical axis extended substantially through or near a middle or back portion of said nacelle, and said second and third of said pipes have a vertical axis extended substantially between said first and fourth of said pipes.

13. The wind turbine station of claim 11, wherein said first of said pipes has a vertical axis extended substantially through or near a front or middle portion of said nacelle, and said second, third and fourth of said pipes have a vertical axis extended substantially through or near a middle or back portion of said nacelle, wherein said second, third and fourth of said pipes have a vertical axis that is substantially extended through or near an axis that extends perpendicular to said horizontal axis of said wind turbine.

14. The wind turbine station of claim 1, wherein at least one sixth of the length of said tower is extended into the ground for supporting said tower and the surrounding ground material provides thermal conductivity properties to said pipes.

15. A wind turbine station for generating energy from the wind, comprising:
a wind turbine adapted to rotate along an axis in conjunction with a nacelle;
a compressor for generating compressed air energy;
a tower for supporting said wind turbine comprising at least one substantially vertically oriented vessel, wherein compressed air energy generated by said compressor can be stored in said vessel; and
wherein at least a significant portion of said tower is extended into the ground for support.

16. The wind turbine station of claim 15, wherein said ground material is concrete and a release valve for releasing water accumulating within said at least one vessel is provided at the bottom of said tower and wherein the surrounding ground material provides thermal conductivity properties to said pipe.

17. A wind farm comprising a plurality of wind turbine stations, wherein each of said wind turbine stations comprises:
a wind turbine adapted to rotate along an axis in conjunction with a nacelle;
a tower for supporting said wind turbine comprising at least one substantially vertically oriented vessel, wherein said vessel is adapted such that compressed air energy generated by a compressor associated with said wind turbine station can be stored within said vessel; and
a pipe that extends between two of said wind turbine stations, said pipe enabling compressed air energy in a first of said wind turbine stations to be distributed to a second of said wind turbine stations, and vice versa, wherein a single turbo expander and generator set releases the compressed air energy stored within said first and second wind turbine stations to generate electricity and/or chilled air.

18. The wind farm of claim 17, wherein said compressors are located inside said nacelles and are driven by the rotational movement of said wind turbines to produce compressed air energy for storage in said vessels, wherein the energy used to drive said compressors is not converted into electricity first.

19. The wind farm of claim 17, wherein generators for generating electricity are located inside said nacelles and are driven by the rotational movement of said wind turbines wherein the electricity generated by said generators is used to drive said compressors and/or can be distributed to a grid or end user directly.

20. The wind farm of claim 17, wherein generators for producing electricity and said compressors are located inside said nacelles and a switch mechanism is provided which allows the rotational energy produced by the wind to be switched between providing energy to drive said generators, on one hand, and/or providing energy to drive said compressors, on the other hand, wherein the extent to which one or the other is used can be switched and adjusted.
